(19) United States
(12) Patent Application Publication
(10) Pub. No.: US 2023/0201895 A1
(43) Pub. Date: Jun. 29, 2023

(54) ORGANIC WASTE DIGESTION AND DECOMPOSITION SYSTEMS AND METHODS THEREOF

(71) Applicant: Patriot Organics LLC, Garden City, NY (US)

(72) Inventors: Alamgir I. Chaudhri, Fort Lauderdale, FL (US); Edward S. Sawchuk, Jamaica, NY (US); Jaclyn R. Hill, Willis, TX (US)

(21) Appl. No.: 17/960,484

(22) Filed: Oct. 5, 2022

Related U.S. Application Data
(60) Provisional application No. 63/252,847, filed on Oct. 6, 2021.

(51) Int. Cl. B09B 3/60; C02F 3/28; C02F 3/00

(52) U.S. Cl. CPC B09B 3/60; C02F 3/006; C02F 3/2866; B09B 2101/70; C02F 2209/42; C02F 2301/046

(57) ABSTRACT

An organic waste digestion and decomposition system includes a digestion chamber, a drain tank, and a discharge tank. The digestion chamber is configured to digest an organic waste mixture disposed therein to produce a liquid digestate. The digestion chamber includes a recirculation spray head configured to spray a first portion of the liquid digestate into the digestion chamber and a drain pan configured to enable the liquid digestate to exit the digestion chamber. The drain tank is configured to receive the liquid digestate from the digestion chamber and includes a first pump configured to pump a second portion of the liquid digestate from the drain tank back to the digestion chamber. The discharge tank is in fluid communication with the drain tank and is configured to receive the liquid digestate from the drain tank and enable the liquid digestate to be discharged from the organic waste digestion and decomposition system.

### CROSS-REFERENCE TO RELATED APPLICATIONS

This application claims priority to U.S. Pat. Application Serial No. 63/252,847, filed Oct. 6, 2021, entitled “ORGANIC WASTE DIGESTION AND DECOMPOSITION SYSTEMS AND METHODS THEREOF”, the disclosure of this application is incorporated herein by reference in its entirety.

### TECHNICAL FIELD

The present disclosure relates to devices and systems for processing food waste, and, in particular, to a system for reducing effluent from food waste digestion systems and methods thereof.

### BACKGROUND

Existing organic waste digestion and decomposition systems in the marketplace employ significant amounts of potable water. The potable water is required to maintain a trickle discharge of effluent (the digested and decomposed organic waste suspended in a liquid digestate). The potable water is often heated to help facilitate the decomposition of the organic waste which increases the amount of energy consumed by the current organic waste digestion and decomposition systems. The trickle discharge of the effluent is required to create a flowable effluent capable of discharging into a sewer line (e.g., a municipal or private sewer line) or into a container for transportation to another location. The trickle discharge flow is generally designed to maintain a four feet per second (fps) flow to keep solids in suspension which consumes significant amounts of water. For example, a 1,500 to 2,000 pounds (650 to 925 kilograms) per day organic waste digestion and decomposition system will consume 200 to 250 gallons (750 liters to 950 liters) of water per day. Accordingly, there is a need for improved organic waste digestion and decomposition systems.

### SUMMARY

This disclosure relates to systems and methods for organic waste digestion and decomposition. In accordance with a first aspect of this disclosure, an organic waste digestion and decomposition system includes a digestion chamber, a drain tank, and a discharge tank. The digestion chamber is configured to digest an organic waste mixture disposed therein to produce a liquid digestate. The digestion chamber includes a recirculation spray head configured to spray a first portion of the liquid digestate into the digestion chamber and a drain pan configured to enable the liquid digestate to exit the digestion chamber. The drain tank is configured to receive the liquid digestate from the digestion chamber and includes a first pump configured to pump a second portion of the liquid digestate from the drain tank back to the digestion chamber. The discharge tank is in fluid communication with the drain tank and is configured to receive the liquid digestate from the drain tank and enable the liquid digestate to be discharged from the organic waste digestion and decomposition system.

Implementations may include one or more of the following features. The digestion chamber may include a water injector configured to supply water to the organic waste mixture in the digestion chamber. In aspects, the digestion chamber may include at least one mixer configured to churn the organic waste mixture. The drain tank may be coupled to the drain pan via a drain channel such that the liquid digestate in the digestion chamber is able to drain into the drain tank via the drain channel (e.g., via gravity).

The first pump may be configured to inject the second portion of the liquid digestate from the drain tank into the digestion chamber to prevent a solid in the organic waste mixture or liquid digestate in the digestion chamber from settling. The drain tank may include a second pump configured to discharge the liquid digestate from the drain tank to the discharge tank. The discharge tank may include a third pump configured to pump the first portion of the liquid digestate to the recirculation spray head. The discharge tank may include a fourth pump configured to agitate the liquid digestate in the discharge tank.

The organic waste digestion and decomposition system further may include a first sensor configured to determine a level of the liquid digestate in the drain tank or the discharge tank. The organic waste digestion and decomposition system further may include a controller configured to selectively operate at least one of the first, second, or third pumps based on the level of the liquid digestate in the drain tank or discharge tank determined by the first sensor. The first pump may be configured to circulate the liquid digestate to maintain the suspension of solids in the liquid digestate.

In other aspects, the first portion of the liquid digestate may be equal to the second portion of the liquid digestate and the first pump is configured to pump the second portion of the liquid digestate to the recirculation spray head.

In other aspects, the discharge tank may include a recirculation pump configured to pump the first portion of the liquid digestate in the discharge tank to the recirculation spray head to enable the recirculation spray head to spray the first portion of the liquid digestate into the digestion chamber.

The present disclosure also provides a digestion and decomposition system for digesting organic waste. The digestion and decomposition system includes a digestion chamber configured to enable decomposition of the organic waste to produce a liquid digestate. The digestion chamber includes a mixing auger configured to churn the organic waste in a fluid to produce the liquid digestate, and a recirculation spray head configured to spray the liquid digestate from above the organic waste in the digestion chamber.

A drain tank is in fluid communication with the digestion chamber. The drain tank is configured to receive the liquid digestate draining out of the digestion chamber. A recirculation spray pump is configured to pump the liquid digestate to the recirculation spray head.

Implementations of the digestion and decomposition system may include one or more of the following features. The digestion and decomposition system may include a discharge pump configured to discharge the liquid digestate from the digestion and decomposition system. A discharge tank may be in fluid communication with the drain tank via a drain pump configured to pump the liquid digestate in the drain tank to the discharge tank.

The agitation pump may be disposed in the drain tank, the recirculation spray pump may be disposed in the drain tank, and a discharge pump may be disposed in the discharge tank. The discharge pump may be configured to discharge the liquid digestate to a sewer or disposal container. The digestion and decomposition system may include a sensor configured to determine a level of the liquid digestate in at least one of the drain tank or the discharge tank.

A controller may be configured to selectively operate at least one of the agitation pump, the recirculation spray pump, or the discharge pump based on the determined level of the liquid digestate in the at least one of the drain tank or the discharge tank. The discharge tank may include a discharge tank agitation pump configured to prevent a solid in the liquid digestate in the discharge tank from settling. The digestion and decomposition system may include a water supply source configured to inject water into the digestion chamber.

This present disclosure additionally provides a method for decomposing organic waste in accordance with aspects of this disclosure. The method may include mixing the organic waste via a mixer in a digestion chamber, wherein the digestion chamber may include a drain pan in fluid communication with a drain tank. The method includes decomposing the organic waste via microbes and water in the digestion chamber to produce a liquid digestate, enabling the liquid digestate to flow from the digestion chamber to the drain tank, and collecting the liquid digestate in the drain tank. The method includes pumping the liquid digestate from the drain tank back to the digestion chamber and pumping the liquid digestate from the drain tank to a discharge tank. The method further includes agitating the liquid digestate in the discharge tank via an agitation pump of the discharge tank to maintain suspension of solids in the liquid digestate in the discharge tank and discharging the liquid digestate from the discharge tank.

Implementations of the above method may include one or more of the following features. The method may include determining a level of the liquid digestate in the drain tank; determining a level of the liquid digestate in the discharge tank and determining a level of the fluid in the digestion chamber. The method may include selectively adding water to the digestion chamber; selectively pumping the liquid digestate between the drain tank, digestion chamber, or discharge tank; or selectively discharging the liquid digestate to the disposal container or sewer based on the determined levels of the liquid digestate in the drain tank or discharge tank or based on the determined level of the fluid in the digestion chamber.

The method may include crushing solids in the organic waste via the mixer in the digestion chamber. The step of pumping the liquid digestate from the drain tank back to the digestion may include at least one of: maintaining a predetermined minimum amount of fluid including the water and the liquid digestate in the digestion chamber; adding additional microbes growing in the drain tank to the digestion chamber, via the liquid digestate, to further decompose the organic waste in the digestion chamber; or mixing the liquid digestate in the discharge chamber to maintain suspension of solids in the liquid digestate in the digestion chamber.

In accordance with another aspect of the present disclosure an organic waste management system may include a digestion chamber configured to enable microbial digestion of organic waste disposed therein to produce a liquid digestate and a drain tank configured to collect the liquid digestate from the digestion chamber. The organic waste management system includes a discharge tank in fluid communication with the digestion chamber and the drain tank. The discharge tank is configured to collect the liquid digestate from the drain tank. At least one recirculation pump is configured to recirculate the liquid digestate from at least one of the drain tank or the discharge tank to the digestion chamber.

Implementations of the organic waste management system may include one or more of the following features. The organic waste management system may include a second pump configured to selectively pump the liquid digestate from the drain tank to the discharge tank based on a level of the liquid digestate in the drain tank determined by a first sensor. The organic waste management system may include a third pump configured to pump the liquid digestate in the discharge tank to a recirculation spray head in the digestion chamber to spray the liquid digestate into the digestion chamber. The organic waste management system may include a fourth pump configured to agitate the liquid digestate in the discharge tank.

### BRIEF DESCRIPTION OF THE DRAWINGS

The above and other aspects and features of the present disclosure will become more apparent in view of the following detailed description when taken in conjunction with the accompanying drawings wherein like reference numerals identify similar or identical elements.

FIG. 1 is a diagram of an organic waste digestion and decomposition system according to an aspect of the present disclosure;

FIG. 2 is a diagram of another organic waste digestion and decomposition system in accordance with another aspect of the present disclosure;

FIG. 3 is a diagram of a controller in accordance with aspects of the present disclosure;

FIG. 4 is a diagram of another organic waste digestion and decomposition system in accordance with another aspect of the present disclosure; and

FIG. 5 is a diagram of a method for digesting and decomposing organic waste in accordance with another aspect of the present disclosure.

Further details and various aspects of this disclosure are described in more detail below with reference to the appended figures.

### DETAILED DESCRIPTION

Aspects of the presently disclosed organic waste digestion and decomposition systems are described in detail with reference to the drawings. It is to be understood that the disclosed systems and methods thereof are merely exemplary of the disclosure and may be embodied in various forms. Well-known functions or constructions are not described in detail to avoid obscuring the disclosure in unnecessary detail. Therefore, specific structural and functional details disclosed herein are not to be interpreted as limiting, but merely as a basis for the claims and as a representative basis for teaching one skilled in the art to variously employ the disclosure in virtually any appropriately detailed structure.

As used herein, the term “organic waste” means and refers to any biodegradable waste that is derived from a living organism, and includes, but is not limited to, any food including leftover restaurant food, unsold grocery items, or household food waste, plants, yard waste (e.g., mulched grass or bush clippings), animal waste (e.g., a dead fish or chicken), paper, cardboard, or the like.

As used herein, the terms “effluent” and “liquid digestate” each refer to a fluid including decomposing and digesting organic waste, microbes (e.g., bacterium, archaea, fungi), enzymes, or other additives configured to enable or enhance decomposition and digestion of the organic waste.

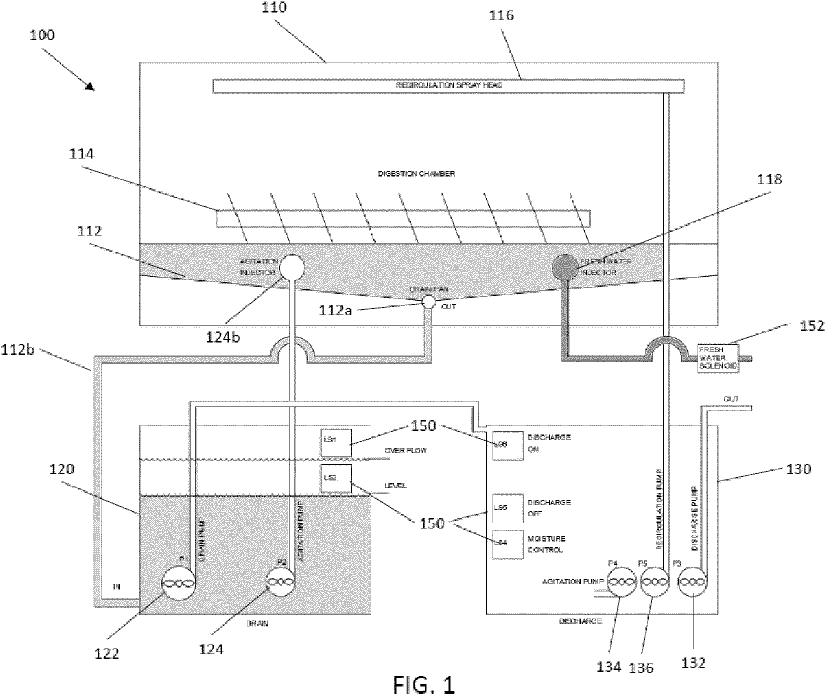

With reference to FIG. 1, an organic waste digestion and decomposition (“OWDD”) system 100 generally includes a digestion chamber 110 and a drain tank 120. The OWDD system 100 may include a discharge tank 130. The digestion chamber 110 includes a drain pan 112, a mixer 114, a recirculation spray head 116, and a water supply source 118. The drain tank 120 tank includes at least one of a drain pump 122 or a first agitation pump 124. The discharge tank includes at least one of a second agitation pump 134, a discharge pump 132, or a recirculation spray head pump 136.

In aspects, when the OWDD system 100 does not include the discharge tank 130, the drain tank 120 may include at least one of the second agitation pump 134, the discharge pump 132, or the recirculation spray head pump 136. In other aspects, the drain tank 120 may include the discharge pump 132 instead of the drain pump 122.

The digestion chamber 110 is configured to receive organic waste deposited therein. The digestion chamber 110 includes an opening, aperture, or other access point through which a person is able to dispose organic waste into the digestion chamber 110. The digestion chamber 110 is configured to receive between, for example, about 1 pound (lbs.) to about 10,000 lbs., about 100 lbs. to about 1,000 lbs., about 100 lbs. to about 2,500 lbs., about 100 lbs. to about 5,000 lbs., about 250 lbs. to about 1,000 lbs., about 250 lbs. to about 10,000 lbs., or at least 500 lbs. of organic waste (or about 0.5 kg to about 4,550 kg, about 45 kg to about 460 kg, about 45 kg to about 1,200 kg, about 45 kg to about 2,300 kg, about 115 kg to about 460 kg, about 115 kg to about 4,550 kg, or at least 225 kg).

In aspects, the OWDD system 100 may be configured to define a volume for receiving and digesting the organic waste from about 5 ft³ (or about 0.15 m³) to about 100 ft³ (or about 3 m³), or about 25 ft³ (or about 0.75 m³) to about 35 ft³ (or about 1 m³). As measured by liquid gallons, the OWDD system 100 may hold from about 30 U.S. gallons (gal.) to about 750 gal., or from about 180 gal. to about 260 gal. Each of the digestion chamber 110, the drain tank 120, and the discharge tank 130 may each define a portion of the total volume of the OWDD system 100. The digestion chamber 110 may define any desired volume of organic waste and fluid as needed. For example, the volume of the digestion chamber 110 may be 1 cubic foot (ft³) (or about 0.25 cubic meters (m³)) to 1000 ft³ (or about 30 m3) or 100 ft³ (about 3 m3) to 500 ft³ (about 15 m³). In another example, the amount of liquid held by the digestion chamber 110 may be about 210 gal., with the drain pain configured to hold about 10 gal. In the latter example, the drain tank 120 may be configured to hold about 2 gal. to about 5 gal., and the discharge tank may be configured to hold about 1 gal. to about 10 gal. The drain tank 120 and the discharge tank 130 may each define any desired volume (e.g., about 1 ft³ to about 100 ft³ or larger). The volume of the discharge tank 130 may be at least 5 gallons to enable a discharge flow rate of liquid digestate of at least 5 gal. per hour.

The digestion chamber 110 enables the organic waste to be mixed and macerated with water and a first composition of microbes, enzymes, and other additives that assist in the decomposition and digestion of the organic waste to produce a liquid digestate. The microbes and enzymes may advantageously assist in reducing oil, fat, or grease in the organic waste. The liquid digestate is produced when the organic waste is sufficiently decomposed, digested, and mixed with the water and the first composition. The liquid digestate may include solid organic waste suspended in the liquid digestate.

The mixer 114 is configured to mix the organic waste with water from the water supply source 118 and the first composition added by a user to the digestion chamber 110. The mixer 114 may be an auger, a helical screw mixer, a paddle mixer, or any other suitable mixer known by those of ordinary skill in the art. The mixer 114 may also be configured to crush, break, or otherwise mash the organic waste to enable more efficient maceration, decomposition, and digestion of the organic waste.

The drain pan 112 is disposed at a bottom of the digestion chamber 110. The drain pan 112 is configured to enable liquid digestate in the digestion chamber 110 to exit and flow out of the digestion chamber 110 to the drain tank 120 via gravity. The drain pan 112 includes a drain 112a at a lowest point of the drain pan 112 and is sloped such that liquid digestate flows towards the drain 112a. The drain pan 112 may include a net, filter, grate, or other screen (not shown) configured to prevent large pieces of solid organic material from clogging the OWDD system 100, 200, and may have openings of about 1/16 of an inch. The net, filter, grate, or other screen may be disposed above the drain pan 112 within the digestion chamber 110. The net filter, grate, or other screen may be configured to withstand the weight of solid organic waste disposed therein.

The drain tank 120 is in fluid communication with the digestion chamber 110. The drain tank 120 is configured to receive liquid digestate from the digestion chamber 110. The drain tank 120 may be in fluid communication with the digestion chamber 110 via a drain channel 112b of the drain 112a of the drain pan 112. In aspects, the drain 112a may be directly open to the drain tank 120.

The microbes, enzymes, and other additives in the liquid digestate further digest and decompose the organic waste in the liquid digestate in the drain tank 120. The microbes may grow and/or multiply in the drain tank 120 the longer the liquid digestate is in the drain tank 120.

The first agitation pump 124 is configured to recirculate liquid digestate from the drain tank 120 to the digestion chamber 110. Advantageously, by pumping the liquid digestate in the drain tank 120 back to the digestion chamber 110, microbes that have multiplied and grown in the drain tank 120 and any enzymes in the drain tank are circulated back to the digestion chamber 110 to further aid digestion and decomposition of the organic waste in the digestion chamber 110. Further, the first agitation pump 124 is configured to inject the liquid digestate from the drain tank into the digestion chamber 110 to prevent solids within the organic mixture or liquid digestate in the digestion chamber from settling in the digestion chamber 110. Thus, fluid and solids in the digestion chamber 110 are kept in motion or stirred to maintain suspension of solids in the liquid digestate. The first agitation pump 124 may be coupled to a first agitation injector 124b in the digestion chamber 110. The first agitation injector 124b injects the liquid digestate from the drain tank 120 at a desired velocity to mix the fluid in the digestion chamber 110.

The drain pump 122 of the drain tank 120 is configured to pump liquid digestate out of the drain tank 120. Generally, the drain pump 122 is configured to pump liquid digestate from the drain tank 120 to the discharge tank 130. In aspects, where the OWDD system 100 does not include a discharge tank 130, the drain pump 122 may be configured to pump liquid digestate from the drain tank 120 to a bulk container for transport, removal, or other disposal of the liquid digestate or to a sewer. The drain pump 122 may be disposed in the drain tank 120 or otherwise in fluid communication with the drain tank 120 and the discharge tank 130.

The discharge tank 130 is in fluid communication with the drain tank 120 and is configured to receive liquid digestate from the drain tank 120. The second agitation pump 134 is disposed in the discharge tank 130 and configured to agitate or stir the liquid digestate in the discharge tank 130 to maintain the solids in the liquid digestate in the discharge tank in suspension. The second agitation pump 134 is configured to prevent solids in the discharge tank 130 from settling at the bottom of the discharge tank 130 by ensuring the liquid digestate is moving within the discharge tank. The second agitation pump 134 may be disposed adjacent a bottom floor of the discharge tank 130.

The recirculation spray head pump 136 is in fluid communication with the liquid digestate in the discharge tank 130 and is in fluid communication with the recirculation spray head 116. The recirculation spray head pump 136 is configured to pump liquid digestate from the discharge tank to the recirculation spray head 116. The recirculation spray head 116 sprays liquid digestate onto the organic waste. The recirculation spray head 116 may be disposed at the top of the digestion chamber 110 to direct liquid digestate down toward the organic waste. For example, organic waste above the mixer 114 may be sprayed with liquid digestate pumped by the recirculation spray head pump 136 from the discharge tanked to the recirculation spray head 116. The recirculation spray head 116 thus enables the organic waste in the digestion chamber 110 to be macerated even when the organic waste is not at the bottom of the digestion chamber 110 (where the fluid in the digestion chamber naturally collects due to gravity) as liquid digestate is added from above. In aspects the recirculation spray head may be disposed at the side of the digestion chamber 110 and configured to spray liquid digestate in a suitable direction to moisten organic waste disposed in the digestion chamber 110.

The discharge pump 132 is configured to pump liquid digestate from the discharge tank 130 to the bulk container for transport, removal, or other disposal of the liquid digestate or to the sewer. The discharge pump 132 may be disposed in the discharge tank 130 or otherwise in fluid communication with the discharge tank 130 so as to be able to pump liquid digestate out of the OWDD system 100.

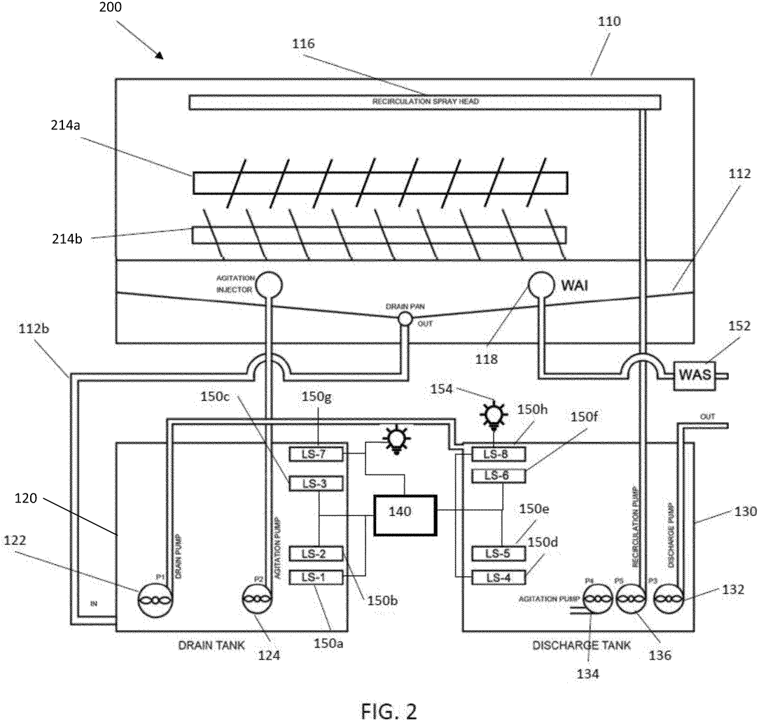

With reference to FIG. 2, there is shown another organic waste and digestion (“OWDD”) system 200. OWDD system 200 includes the digestion chamber 110, the drain tank 120, and the discharge tank 130. OWDD system 200 further includes all the features of OWDD 100 discussed above, and for the sake of brevity, only the differences are discussed below.

The digestion tank 110 of OWDD system 200 includes a plurality of mixers 214 having a first mixer 214a and a second mixer 214b. The first and second mixers 214a, 214b may be disposed parallel, adjacent, or stack relative to each other. The first mixer 214a may rotate in a first direction and the second mixer 214b may rotate in a second direction opposite the first direction. The first and second mixers 214a, 214b, may be adjacent each other such that organic waste is mashed, crushed, or otherwise reduced as it passes between the first and second mixers 214a, 214b.

With reference to FIGS. 1 and 2, the OWDD systems 100, 200 may each include a controller 140 or a sensor 150. The sensor 150 may be in electrical or wireless communication with the controller 140. The controller 140 is configured to selectively control operation of each of the drain pump 122, first agitation pump 124, discharge pump 132, second agitation pump 134, or recirculation spray head pump 136 independently. For example, controller 140 may activate the operation of the drain pump 122 and deactivate the operation of recirculation spray head pump 136. In another example, the controller may activate the drain pump 122, the first agitation pump 124, the second agitation pump 134, and the recirculation spray head pump 136 but not the discharge pump 132.

The controller 150 may also control operation of a water-supply valve 152 configured to restrict or enable water to be supplied by the water supply source 118. The water-supply valve 152 may be a solenoid valve or any other suitable electrical or mechanical valve known by those of ordinary skill in the art.

The sensor 150 may include a fluid level sensor or a moisture sensor. In aspects, OWDD systems 100, 200 may include a plurality of sensors 150 having a first sensor 150a, a second sensors 150b, a third sensors 150c, a fourth sensor 150d, a fifth sensors 150e, a sixth sensor 150f, a seventh sensor 150g, or an eighth sensor 150h. The plurality of sensors 150 may include any number of sensors desired.

The first sensor 150a is configured to determine a minimum level of fluid in the drain tank 120 (e.g., detect if the liquid digestate is above or below a predetermined minimum level in the drain tank 120). The second sensor 150b is configured to determine if a fluid is at or below a drain threshold fluid level in the drain tank 120. The drain threshold fluid level is a predetermined level at which, when the liquid digestate is at or below, the drain pump 122 stops pumping the liquid digestate from the drain tank 120 to the discharge tank 130. The third sensor 150c is configured to determine if a fluid is at or above a drain pump activation fluid level in the drain tank 120. The drain pump activation fluid level is a predetermined level at which, when the liquid digestate is at or above the drain pump activation fluid level, the drain pump 122 begins to pump the liquid digestate from the drain tank 120 to the discharge tank 130 until, for example, the liquid digestate is at the drain threshold fluid level.

The fourth sensor 150d is configured to determine the level of fluid in the discharge tank 130 to indicate if the system is dry or sufficiently filled with fluid. When the fourth sensor 150d determines the system is dry, the controller 150 may operate the water-supply valve 152 so that water may be supplied into the digestion chamber 110 via the water supply source 118.

The fifth sensor 150e is configured to determine a minimum discharge level of fluid (e.g., the liquid digestate) in the discharge tank 130 below which the discharge pump 132 stops discharging the liquid digestate from the either of the OWDD systems 100, 200. The sixth sensor 150f is configured to determine discharge threshold level, at or above which the discharge pump 132 begins to pump the fluid (e.g., the liquid digestate) in the discharge tank 130 out of either of the OWDD systems 100, 200.

The seventh and eighth sensors 150f, 150g are configured to determine if the drain tank 120 or the discharge tank 130, respectively, are overfilled. The seventh and eighth sensors 150f, 150g may each provide a signal when the drain tank 120 or the discharge tank 130 are determined to be overfilled. The signal may be a light, a sound, tactile feedback device (vibration), or a notification on a computing device (e.g., a smartphone, tablet, laptop, desktop or other computing device). An overfill indicator 154 may be included to indicate if both the seventh and eighth sensors 150f, 150g, determine the drain tank 120 and the discharge tank 130 to be overfilled.

The plurality of sensors 150 may be fluid level switches and the data collected by the plurality of sensors 150 may direct the logic of the controller 140 to operate pumps 122, 124, 132, 134, and 135.

Table 1 below illustrates one exemplary scheme with which the various pumps of the OWDD 100 or 200 may be operated based on data from the plurality of sensors 150. Table 1 references the pumps and sensor via the corresponding reference numerals in the drawings.

TABLE 1

Exemplary logic scheme for control/ operation of the various pumps of the OWDD 200 based on the plurality of sensors 150

| Pump | 150 a | | 150 b | | 150 c | | 150 d | | 150 e | | 150 f | | 150 g | | 150 h | |
|---|---|---|---|---|---|---|---|---|---|---|---|---|---|---|---|---|
| | 0 | 1 | 0 | 1 | 0 | 1 | 0 | 1 | 0 | 1 | 0 | 1 | 0 | 1 | 0 | 1 |
| 122 | 0 | E | 0 | E | E | E | X | X | E | E | E | 0 | X | X | X | X |
| 124 | 0 | E | E | E | E | 0 | X | X | X | X | X | 0 | X | X | X | X |
| 132 | X | X | X | X | X | X | 0 | E | 0 | E | E | E | X | X | X | X |
| 134 | X | X | X | X | X | X | 0 | E | X | X | X | X | X | X | X | X |
| 136 | X | X | X | X | X | X | 0 | E | E | E | E | 0 | X | X | X | X |
| 152 | E | 0 | X | X | X | X | E | 0 | X | X | X | X | E | 0 | E | 0 |
| 154 | X | X | X | X | X | X | X | X | X | X | X | X | 0 | 1 | 0 | 1 |

X-No Effect E-Enabled (Controlled by Logic) 1-On 0-OFF/Disabled

With reference to Table 1, when the level of liquid digestate is lower than the minimum level of the drain tank (e.g., the level of liquid digestate is below 3 inches (“in.”) from a bottom of the drain tank 120), the first sensor 150a is in the off or disabled state “0”, and when the level of liquid digestate is higher than the minimum level of the drain tank 120 (e.g., the level of liquid digestate is above 3.25 in. from the bottom of the drain tank 120), the first sensor 150a is in the on or enabled state “1”. Similarly, when the level of liquid digestate is lower than the drain threshold fluid level of the drain tank 120 (e.g., the level of liquid digestate is below 4 in. from the bottom of the drain tank 120), the second sensor 150b is in the off or disabled state “0”, and when the level of liquid digestate is higher than the drain threshold fluid level of the drain tank 120 (e.g., the level of liquid digestate is above 4.25 in. from the bottom of the drain tank 120), the second sensor 150b is in the on or enabled state “1”.

With continued reference to Table 1, when the level of liquid digestate is lower than the drain pump activation fluid level of the drain tank 120 (e.g., the level of liquid digestate is below 6 in. from the bottom of the drain tank 120), the third sensor 150c is in the off or disabled state “0”, and when the level of liquid digestate is higher than the drain pump activation fluid level of the drain tank 120 (e.g., the level of liquid digestate is above 6.25 in. from the bottom of the drain tank 120), the third sensor 150c is in the on or enabled state “1”. When the level of liquid digestate is lower than the dry level of the discharge tank 130 (e.g., the level of liquid digestate is below 3 in. from the bottom of the discharge tank 130), the fourth sensor 150d is in the off or disabled state “0”, and when the level of liquid digestate is higher than the dry level of the discharge tank 130 (e.g., the level of liquid digestate is above 3.25 in. from the bottom of the discharge tank 130), the fourth sensor 150d is in the on or enabled state “1”. When the level of liquid digestate is lower than the minimum discharge level of the discharge tank 130 (e.g., the level of liquid digestate is below 4 in. from the bottom of the discharge tank 130), the fifth sensor 150e is in the off or disabled state “0”, and when the level of liquid digestate is higher than the minimum discharge level of the discharge tank 130 (e.g., the level of liquid digestate is above 4.25 in. from the bottom of the discharge tank 130), the fifth sensor 150e is in the on or enabled state “1”.

With continued reference to Table 1, when the level of liquid digestate is lower than the discharge threshold level of the discharge tank 130 (e.g., the level of liquid digestate is below 10 in. from the bottom of the discharge tank 130), the sixth sensor 150f is in the off or disabled state “0”, and when the level of liquid digestate is higher than the discharge threshold level of the discharge tank 130 (e.g., the level of liquid digestate is above 10.25 in. from the bottom of the discharge tank 130), the sixth sensor 150f is in the on or enabled state “1”. When the level of liquid digestate is lower than an overfill level of the drain tank 120 (e.g., the level of liquid digestate is below 7 in. from the bottom of the drain tank 120), the seventh sensor 150g is in the off or disabled state “0”, and when the level of liquid digestate is higher than the overfill level of the drain tank 120 (e.g., the level of liquid digestate is above 7.25 in. from the bottom of the drain tank 120), the seventh sensor 150g is in the on or enabled state “1”.

With continued reference to Table 1, when the level of liquid digestate is lower than an overfill level of the discharge tank 130 (e.g., the level of liquid digestate is below 11 in. from the bottom of the drain tank 120), the eighth sensor 150h is in the off or disabled state “0”, and when the level of liquid digestate is higher than the overfill level of the discharge tank 130 (e.g., the level of liquid digestate is above 11.25 in. from the bottom of the discharge tank 130), the eighth sensor 150h is in the on or enabled state “1”. When fourth sensor 150d, seventh sensor 150g, or eighth sensor 150h are in the “1” state, the water supply valve 152 is in the off state “0” (e.g., the valve is closed and no water is supplied via the water supply source 118), and the water supply valve 152 is in the on state “1” (e.g., the valve is open and water is supplied via the water supply source 118) when each of the fourth sensor 150d, seventh sensor 150g, and sixth sensor 150f are in the “0” state. When the seventh sensor 150g or the eighth sensor 150h are in the “0” state the overfill indicator 154 is in the off state “0”, and the overfill indicator 154 is in the on state “1” when either the seventh sensor 150g or eighth sensor 150h are in the “1” state. In aspects, the various levels determined by the plurality of sensors 150 may be accomplished by a single sensor, two sensors, or any number of sensors desired.

Each of the drain pump 122, first agitation pump 124, discharge pump 132, second agitation pump 134, and recirculation spray head pump 136 may be turned on or off by the controller 140 based on a state of at least one of the sensors of the plurality of sensors 150 as indicated in Table 1. In aspects, each of the drain pump 122, first agitation pump 124, discharge pump 132, second agitation pump 134, or recirculation spray head pump 136 may be operated based on a respective sensor 150 and the controller 140.

One of ordinary skill in the art will envision a variety of similar schemes or controller logic through which each of the drain pump 122, first agitation pump 124, discharge pump 132, second agitation pump 134, or recirculation spray head pump 136 may be operated and this disclosure is not limited to the scheme and controller logic shown in Table 1 or to the number of sensors of the plurality of sensors 150 discussed above. When enabled, each of the drain pump 122, first agitation pump 124, discharge pump 132, second agitation pump 134, or recirculation spray head pump 136 may each be operated continuously or intermittently (e.g., pulsed) until the respective sensor indicates the “0” state such that the controller 140 turns the respective pump off or until a predetermined amount of time has lapsed.

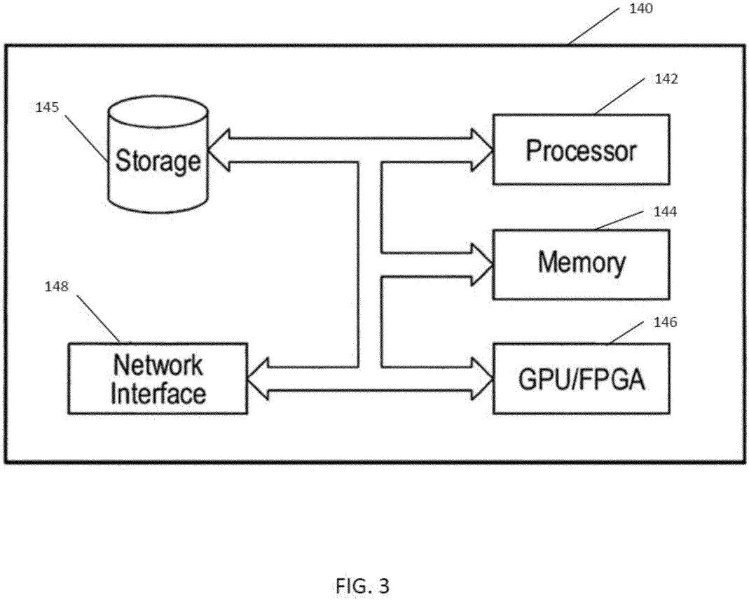

With reference to FIG. 3, the controller 140 includes a processor 142 that is connected to a computer-readable storage medium or a memory 144. The computer-readable storage medium or memory 144 may be a volatile type memory, e.g., RAM, or a non-volatile type memory, e.g., flash media, disk media, etc. In various aspects of the present disclosure, the processor 142 may be any type of processor such as, without limitation, a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the present disclosure, the memory 144 can be random access memory, read-only memory, magnetic disk memory, solid-state memory, optical disc memory, and/or another type of memory (e.g., RAM, ROM, EEPROM, flash memory, or the like). In some aspects of the present disclosure, the memory 144 can be separate from the controller 140 and can communicate with the processor 142 through communication buses of a circuit board and/or through communication cables such as serial ATA cables or other types of cables. The memory 144 includes computer-readable instructions that are executable by the processor 142 to operate the controller 140. The memory 144 may include volatile (e.g., RAM) and non-volatile storage configured to store data, including software instructions for operating the OWDD system 100. In other aspects of the disclosure, the controller 140 may include a network interface 148 to communicate with other computers, controllers, or to a server. Network interface 148 may communicate with satellites and/or telecommunication systems. A database 145 and/or a storage device may be used for storing data. In other aspects of the disclosure, the controller 140 may include a Graphics Processing Unit (“GPU”) or a Field Programmable Gate Array (“FPGA”) which may process many pieces of data simultaneously and be programmed with performance requirements.

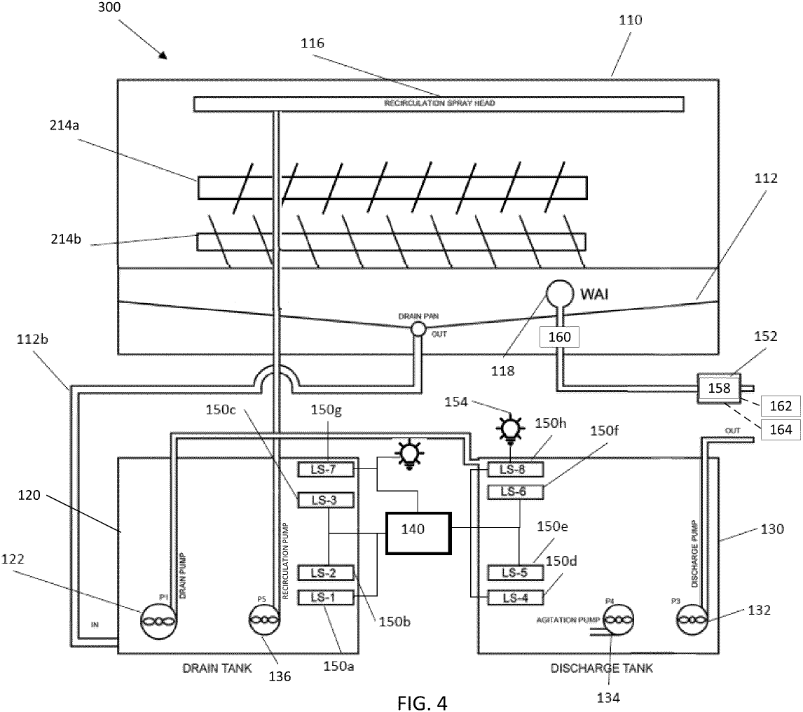

With reference to FIG. 4, there is shown another organic waste and digestion (“OWDD”) system 300. OWDD system 300 includes digestion chamber 110, drain tank 120, discharge tank 130, and many of the features of OWDD 100 and 200 discussed above, and for the sake of brevity, only the differences are discussed below.

In OWDD system 300, the drain tank 120 includes the drain pump 122 and the recirculation spray head pump 136. As previously stated, the drain pump 122 is configured to pump liquid digestate from the drain tank 120 to the discharge tank 130. The recirculation spray head pump 136 is in fluid communication with the liquid digestate in the drain tank 120 and is in fluid communication with the recirculation spray head 116. The recirculation spray head pump 136 is configured to pump liquid digestate from the drain tank 120 to the recirculation spray head 116. The recirculation spray head 116 sprays liquid digestate onto the organic waste to add liquid digestate to the digestion chamber 110 from above.

OWDD system 300 may include additional moisture level controls. The water-supply valve 152 may include a main water solenoid 158 and may provide fresh water to a water fill solenoid 160, a moisture spray solenoid 162, and a water rinse solenoid 164. The water fill solenoid 160 may control a flow of fresh water through water supply source 118 to fill digestion chamber 110 to a minimum fluid level required for efficient operation. The moisture spray solenoid 162 may control a flow of fresh water through a spay head on top of product inside of digestive chamber 110. The water rinse solenoid 164 may control a flow of fresh water to periodically rinse and clean sediments and debris from plurality of sensors 150, which may be float switches, and other critical components.

In another example, sensors 150a, 150b, 150c, 150d, 150e, and 150f may be fluid level switches which direct the logic of pumps and solenoids to operate system 300. A logic output may be LOW when fluid is below a float level of float switch 150a, 150b, 150c, 150d, 150e, or 150f and a logic output may be HIGH when a fluid level is at or above a float activation level of float switch 150a, 150b, 150c, 150d, 150e, or 150f. The states and logic outputs of float switches 150a, 150b, 150c, 150d, 150e, or 150f may be used to determine how pump 122, pump 132, pump 134, pump 136, main water solenoid 158, water fill solenoid 160, moisture spray solenoid 162, and water rinse solenoid 164 operate. Sensors 150g and 150h may be overfill fluid level switches and may be wired in a failsafe method so that they as always ON when in a normal inactive state. Logic output from fluid level switches 150g and 150h may be HIGH when fluid is below a float level of fluid level switches 150g and 150h and a logic output may be LOW when a fluid level is at or above a float activation level of fluid level switches 150g and 150h. The states and logic outputs of fluid level switches 150g and 150h may be used to determine how pump 132, main water solenoid 158, water fill solenoid 160, moisture spray solenoid 162, and water rinse solenoid 164 operate.

For example, the following logic may be utilized to control operation of pump 122. When float level of float switches 150b, 150c, and 150h are HIGH and pump 132 is off, pump 122 is ON. When float level of float switches 150b and 150h are LOW or pump 132 is ON, pump 122 is OFF.

The following logic may be used to control operation of pump 136. When float level of float switches 150a and 150b are HIGH pump 136 is ENABLED. When float level of float switch 150a is LOW, pump 136 is OFF. When pump 136 is ENABLED the operation of pump 136 is as follows:
1) Run continuously or timed on/off cycle on both Run and Rest cycles
2) Run continuously or timed on/off cycles on Run cycle only
3) Run continuously or timed on/off cycles on Rest cycle only
4) Pump 136 may be ENABLED or DISABLED when fill doors are open

The following logic may be used to control operation of pump 132. When float level of float switches 150e and 150f are HIGH, pump 132 is On in a NORMAL MODE. When float level of float switch 150e is LOW, pump 132 is OFF and Pump 122 is ENABLED. Pump 132 is DISABLED when the system is in an INITIALIZE/STORE MODE.

The following logic may be used to control operation of pump 134. When float level of float switches 150d and 150e are HIGH, pump 134 is On to agitate the contents of the discharge tank 130. When float level of float switch 150d is LOW, pump 134 is OFF.

The following logic may be used to control operation of main water solenoid 158. Main water solenoid 158 is ENABLED when water fill solenoid 160, moisture spray solenoid 162, or water rinse solenoid 164 have logic to request water as detailed below. Main water solenoid 158 is DISABLED when either float level of float switch 150g or 150h are HIGH in NORMAL MODE. Main water solenoid 158 is DISABLED when both float level of float switch 150g and 150h are HIGH in INITIALIZE/STORE MODE.

The following logic may be used to control operation of water fill solenoid 160. Water fill solenoid 160 is used to fill system 300 with fresh water to keep system 300 at a minimum operating fluid level or to fill system 300 to INITIALIZE/STORE level. In INITIALIZE/STORE MODE, water fill solenoid 160 is ON if float level of float switch 150g or 150h are LOW, and water fill solenoid 160 is OFF when float level of float switch 150g and 150h are both HIGH. In NORMAL MODE, water fill solenoid 160 is ON if float level of float switch 150a is LOW, and water fill solenoid 160 is OFF when float level of float switch 150b is HIGH.

The following logic may be used to control operation of moisture spray solenoid 162. Moisture spray solenoid 162 is used to spray fresh water to the top of the product in digestive tank 110 via a spray head after fill doors are closed. Moisture spray solenoid 162 is ENABLED when the fill doors are closed. When ENABLED moisture spray solenoid 162 will run for a preset amount of time. When DISABLED, moisture spray solenoid 162 will not operate.

The following logic may be used to control operation of water rinse solenoid 164. Water rinse solenoid 164 is used to spray fresh water on a float switch tree for level float switches 150a, 150b, 150c, and 150g, and a float switch tree for float switches 150d, 150e, 150f, and 150h for a predetermined amount of time on a preselected schedule. Water rinse solenoid 164 is ENABLED in NORMAL MODE.

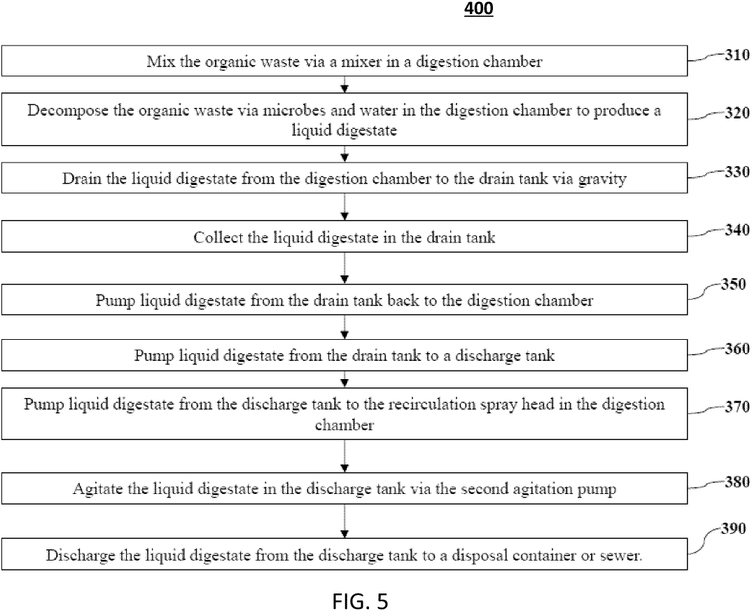

With reference to FIG. 5, a method 400 for digesting and decomposing organic waste via an OWDD system 100, 200, or 300 is shown in accordance with aspects of the present disclosure. Although the steps of FIG. 5 are shown in a particular order, the steps need not all be performed in the specified order, and certain steps can be performed in another order. Additionally, where it is indicated that at least one step is performed, one or more of the indicated steps may be eliminated. For simplicity, FIG. 5 will be described below with the controller 140 performing the operations. However, in various aspects, the operations of FIG. 5 may be performed in part by the controller 140 of FIG. 3 and in part by another device, such as a remote server. These variations are contemplated to be within the scope of the present disclosure.

Initially, at operation 310, organic waste is mixed in the digestion chamber 110. The operation 310 may include depositing organic waste in the digestion chamber 110. The operation 310 may include mixing the organic waste via the mixer 114 or mixers 214a, 214b. The operation 310 may include crushing or mashing the organic waste in the digestion chamber 110 via the mixer 114 or mixers 214a, 214b. At operation 320, the organic waste is decomposed and/or macerated via microbes, enzymes, or other additives in fluid in the digestion chamber 110 (e.g., water from the water supply source 118 and/or liquid digestate) to produce a liquid digestate. At operation 330, the liquid digestate is drained from the digestion tank 110 to the drain tank 120. Operation 330 may include collecting the liquid digestate in the drain pan 112 to enable the liquid digestate to drain via gravity to the drain tank 120.

At operation 340, the liquid digestate is collected in the drain tank 120. At operation 350, the liquid digestate is pumped from the drain tank 120 back to the digestion chamber 110. Advantageously, the operation 350 maintains a predetermined minimum amount of fluid in the digestion chamber 110, adds additional microbes growing in the drain tank and more enzymes to the digestion chamber 110 to further decompose the organic waste in the digestion chamber 110, or mix the liquid digestate (e.g., the liquid digestate collected in the drain pan 112) in the digestion chamber 110 to maintain suspension of solids in the liquid digestate. In systems 100 and 200 first agitation pump 124 is configured to recirculate liquid digestate from the drain tank 120 to the digestion chamber 110. In system 300, the recirculation spray head pump 136 is configured to pump liquid digestate from the drain tank 120 to the recirculation spray head 116 and spray liquid digestate onto the organic waste to add liquid digestate to the digestion chamber 110.

At operation 360, the drain pump 122 pumps liquid digestate from the drain tank 120 to the discharge tank 130. At operation 370, optionally some of the liquid digestate in the discharge tank 130 is pumped by the recirculation spray head pump 136 from the discharge tank 130 to the recirculation spray head 116 in the digestion chamber 110 to spray the liquid digestate onto the organic waste in the digestion chamber 110. Operation 370 provides similar advantages to step 350, in that operation 370 enables the recycling or circulation of microbes, enzymes, and other additives, as well as further fluid back to the digestion chamber 110 to further aid in the digestion, decomposition, and maceration of organic waste in the digestion tank 110, and in the OWDD systems 100 or 200.

At operation 380, the liquid digestate in the discharge tank 130 is agitated, mixed, or otherwise stirred by the second agitation pump 134 in the discharge tank 130. At operation 390, the some of the liquid digestate in the discharge tank 130 is pumped, via the discharge pump 132, outside of the OWDD system 100, OWDD system 200, or OWDD system 300 (e.g., to a sewer or disposal container). Operation 380 advantageously maintains solids in the liquid digestate in the discharge tank 130 in suspension such that it may be discharged outside the system as an effluent during operation 390. The method 400 may include, between, at, or before any of the above operations, determining a level of the liquid digestate in the digestion tank 110, in the drain tank 120, or discharge tank 130. The method may include executing any one of operations 310-390 based on the determined level of the liquid digestate in the digestion tank 110, drain tank 120, or discharge tank 130.

The OWDD systems 100, 200, and 300 may operate, in accordance with method 400, in a dry mode (INITIALIZE/STORE MODE), normal mode, or overfill mode. The OWDD systems 100, 200, and 300 operate in the dry mode when used for the first time or when liquid digestate supply in the digestion tank 110, drain tank 120, or discharge tank 130 is low. The dry mode may be characterized as when the fourth sensor 150d, fifth sensor 150e, and sixth sensor 150f are in the “0” state and when the water-supply valve is on or enabled. The normal mode may be characterized as when the pumps drain pump 122, first agitation pump 124, second agitation pump 132, second agitation pump 134, and recirculation spray head pump 136 are in the on or enabled state “1.” The overfill mode may be characterized as when the seventh sensor 150g and eighth sensor 150h are in the “1” state, the water-supply valve 152 is off or disabled, all pumps are on or enabled, and the overfill indicator is on or in the “1” state.

The OWDD systems 100, 200, 300 and the method 400 advantageously reduce the amount of water otherwise required to maintain a desired flow rate (e.g., such as that imposed by law, sewage, or other design constraints), a desired solid-to-liquid ratio in the liquid digestate, while also being energy efficient. The OWDD systems 100, 200, and 300 are configured such that they may be optimally placed at or near a source of organic waste, such as a restaurant, cafeteria, grocery, event, stadium, manufacturer, farm, municipal garbage dump or any other place where organic waste is generated.

The OWDD systems 100, 200, 300 and the method 400 thereof enables a user to decompose and reduce organic waste in volume and weight in an aerobic state thereby substantially reducing shipping or disposal costs and logistics or strains on sewer systems. The discharge pump 132 is a high velocity pump that ensures the liquid digestate flows out at a sufficient rate and may render any large or undigested organic solid waste inconsequential. The OWDD systems 100, 200, and 300 control the amount of water added to the system thereby saving water, which is particularly helpful where water supply is limited (e.g., in a desert) or during periods of droughts. OWDD systems 100, 200, and 300 may reduce water consumption to 1-20 gallons of water per day without any negative impact on the sewer system the liquid digestate is pumped into.

By reducing the amount of water used, the OWDD systems 100, 200, and 300 are cheaper to operate (and the method 400 cheaper to implement). Additionally, the liquid digestate may be dried or used as is as fertilizer for farms, gardens, forests, etc. The liquid digestate may be mixed into compost or subsoils to produce topsoil which improves water retention in, for example, sandy soils and increases the permeability of water and air in clay soils. The liquid digestate and soil mixture acts as an enhanced fertilizer by retaining nutrients and making them available for plant use or growth.

Persons skilled in the art will understand that the structures and methods specifically described herein and shown in the accompanying figures are non-limiting exemplary embodiments, and that the description, disclosure, and figures should be construed merely as exemplary of particular embodiments. It is to be understood, therefore, that the present disclosure is not limited to the precise embodiments described, and that various other changes and modifications may be made by one skilled in the art without departing from the scope or spirit of the present disclosure. Additionally, the elements and features shown or described in connection with certain embodiments may be combined with the elements and features of certain other embodiments without departing from the scope of the present disclosure, and that such modifications and variations are also included within the scope of the present disclosure. Accordingly, the subject matter of this disclosure is not limited by what has been particularly shown and described.

What is claimed is:

1. An organic waste digestion and decomposition system comprising:
a digestion chamber configured to digest an organic waste mixture disposed therein to produce a liquid digestate, the digestion chamber including:
a recirculation spray head configured to spray a first portion of the liquid digestate into the digestion chamber; and
a drain pan configured to enable the liquid digestate to exit the digestion chamber;
a drain tank configured to receive the liquid digestate from the digestion chamber, the drain tank including:
a first pump configured to pump a second portion of the liquid digestate from the drain tank back to the digestion chamber; and
a discharge tank in fluid communication with the drain tank, the discharge tank configured to receive the liquid digestate from the drain tank and enable the liquid digestate to be discharged from the organic waste digestion and decomposition system.

2. The organic waste digestion and decomposition system of claim 1, wherein the digestion chamber further includes a water injector configured to supply water to the organic waste mixture in the digestion chamber.

3. The organic waste digestion and decomposition system of claim 1, wherein the drain tank is coupled to the drain pan via a drain channel such that the liquid digestate in the digestion chamber is able to drain into the drain tank via the drain channel.

4. The organic waste digestion and decomposition system of claim 1, wherein the drain tank further includes a second pump configured to discharge the liquid digestate from the drain tank to the discharge tank.

5. The organic waste digestion and decomposition system of claim 4, wherein the discharge tank includes a third pump configured to pump the first portion of the liquid digestate to the recirculation spray head.

6. The organic waste digestion and decomposition system of claim 5, wherein the discharge tank further includes a fourth pump configured to agitate the liquid digestate in the discharge tank.

7. The organic waste digestion and decomposition system of claim 6, further including a first sensor configured to determine a level of the liquid digestate in the drain tank or the discharge tank.

8. The organic waste digestion and decomposition system of claim 7, further including a controller configured to selectively operate at least one of the first, second, or third pumps based on the level of the liquid digestate in the drain tank or discharge tank determined by the first sensor.

9. The organic waste digestion and decomposition system of claim 1, wherein the first portion of the liquid digestate is equal to the second portion of the liquid digestate and the first pump is configured to pump the second portion of the liquid digestate to the recirculation spray head.

10. A digestion and decomposition system for digesting organic waste comprising:
a digestion chamber configured to enable decomposition of the organic waste to produce a liquid digestate, the digestion chamber including:
a mixing auger configured to churn the organic waste in a fluid to produce the liquid digestate; and
a recirculation spray head configured to spray the liquid digestate from above the organic waste in the digestion chamber;
a drain tank in fluid communication with the digestion chamber, the drain tank configured to receive the liquid digestate draining out of the digestion chamber; and
a recirculation spray pump configured to pump the liquid digestate to the recirculation spray head.

11. The digestion and decomposition system of claim 10, further comprising a discharge pump configured to discharge the liquid digestate from the digestion and decomposition system.

12. The digestion and decomposition system of claim 11, further comprising a discharge tank in fluid communication with the drain tank via a drain pump configured to pump the liquid digestate in the drain tank to the discharge tank.

13. The digestion and decomposition system of claim 12, wherein the agitation pump is disposed in the drain tank, the recirculation spray pump is disposed in the drain tank, and a discharge pump is disposed in the discharge tank; and
wherein the discharge pump is configured to discharge the liquid digestate to a sewer or disposal container.

14. The digestion and decomposition system of claim 13, further comprising a sensor configured to determine a level of the liquid digestate in at least one of the drain tank or the discharge tank; and
a controller configured to selectively operate at least one of the agitation pump, the recirculation spray pump, or the discharge pump based on the determined level of the liquid digestate in the at least one of the drain tank or the discharge tank.

15. The digestion and decomposition system of claim 12, the discharge tank further includes a discharge tank agitation pump configured to prevent a solid in the liquid digestate in the discharge tank from settling.

16. A method for decomposing organic waste comprising:
mixing the organic waste via a mixer in a digestion chamber, the digestion chamber including a drain pan in fluid communication with a drain tank;
decomposing the organic waste via microbes and water in the digestion chamber to produce a liquid digestate;
enabling the liquid digestate to flow from the digestion chamber to the drain tank;
collecting the liquid digestate in the drain tank;
pumping the liquid digestate from the drain tank back to the digestion chamber;
pumping the liquid digestate from the drain tank to a discharge tank;
agitating the liquid digestate in the discharge tank via an agitation pump of the discharge tank to maintain suspension of solids in the liquid digestate in the discharge tank; and
discharging the liquid digestate from the discharge tank.

17. The method of claim 16, further comprising discharging the liquid digestate from the discharge tank to a disposal container or sewer.

18. The method of claim 16, further comprising crushing solids in the organic waste via the mixer in the digestion chamber.

19. The method of claim 16, further comprising determining a level of the liquid digestate in the drain tank with a first sensor or determining a level of the liquid digestate in the discharge tank with a second sensor.

20. The method of claim 19, further comprising discharging the liquid digestate from the discharge tank based on the determined level of the liquid digestate in the drain tank or the determined level of the liquid digestate in the discharge tank.
